(19) United States
(12) Patent Application Publication
(10) Pub. No.: US 2026/0280696 A1
(43) Pub. Date: Sep. 17, 2026

(54) SYSTEMS AND METHODS FOR REMOTE DETECTION AND MEASUREMENT OF OPTICAL SYSTEM MISALIGNMENTS IN FREE-SPACE OPTICAL COMMUNICATION TERMINALS

(71) Applicant: Astrolight UAB, Vilnius (LT)

(72) Inventor: Julijanas ZELUDEVICIUS, Vilnius (LT)

(21) Appl. No.: 19/563,315

(22) Filed: Mar. 11, 2026

Related U.S. Application Data
(60) Provisional application No. 63/770,039, filed on Mar. 11, 2025.

(51) Int. Cl. H04B 10/077; G02B 26/08; H04B 10/112; H04B 10/50

(52) U.S. Cl. CPC H04B 10/077; G02B 26/0833; H04B 10/1123; H04B 10/503

(57) ABSTRACT

A system for remotely detecting and measuring optical system misalignments includes a direction selective optical component configured to propagate an optical signal; a fiber end at a distal end of the direction selective optical component configured to emit the optical signal into free-space; a fiber collimator configured to collimate the emitted optical signal; a fast-steering mirror configured to control a pointing direction of the optical signal in free-space; an optical system configured to relay the optical signal; and an optical output element configured to transmit the optical signal, wherein a portion of the optical signal is reflected from the optical output element, back-coupled into the fiber collimator, and routed through the direction selective optical component to detect a pointing misalignment.

### CROSS-REFERENCE TO RELATED APPLICATION

This application claims the benefit of and priority to U.S. Provisional Patent Application No. 63/770,039 filed on Mar. 11, 2025, the entire contents of which is incorporated by reference herein.

### TECHNICAL FIELD

The subject matter of the present disclosure relates generally to systems and methods for detecting and characterizing optical system misalignments in free-space optical (FSO) communication terminals, and in particular to systems and methods that utilize angular control of a transmitted optical beam and measurement of optical power coupled to a transmission fiber.

### BACKGROUND

Current free-space optical (FSO) communication systems rely on precise alignment between transmitter and receiver terminals to maintain efficient optical coupling and link stability. However, alignment of the optical system can degrade over time due to environmental and mechanical perturbations such as temperature variation, vibration, structural deformation, and stresses encountered during launch or operation in spaceborne platforms. Conventional approaches for detecting and compensating transmitter misalignment typically employ auxiliary optical assemblies, imaging sensors, or position sensitive detectors such as quadrant photodiodes or cameras to monitor beam pointing direction and generate feedback control signals. While such architectures can achieve accurate pointing, they increase overall system complexity, mass, and cost, and introduce additional optical paths that may themselves become misaligned. These limitations complicate system calibration, reduce reliability, and limit suitability for compact, high precision FSO terminals operating in demanding terrestrial or aerospace environments.

Accordingly, there remains a need for systems and methods capable of remotely detecting and measuring optical system misalignments within FSO transmitters without the use of separate imaging subsystems or external reference detectors. In particular, there is a need for simple, self-referenced architectures that utilize existing transmitter beam steering capabilities such as fast-steering mirrors or equivalent opto-mechanical deflectors and measurements of optical power back-coupled into the transmission fiber to determine and correct pointing deviations relative to the transmitter output aperture.

### SUMMARY

In accordance with aspects of the present disclosure, a system for remotely detecting and measuring optical system misalignments includes a direction selective optical component configured to propagate an optical signal; a fiber end disposed along a distal end of the direction selective optical component configured to emit the optical signal into free-space; a fiber collimator configured to collimate the optical signal emitted from the fiber end; a fast-steering mirror configured to control a pointing direction of the optical signal in free-space once emitted by the fiber end; an optical system configured to relay the optical signal; and an optical output element configured to transmit the optical signal, wherein a portion of the optical signal is reflected from the optical output element, back-coupled into the fiber collimator, and routed through the direction selective optical component for detection of a pointing misalignment.

In an aspect of the present disclosure, the optical signal including at least one wavelength may be generated and transmitted by a laser source.

In an aspect of the present disclosure, the fast-steering mirror may be an opto-mechanical device configured to deflect a direction of the optical signal within two mutually orthogonal planes.

In an aspect of the present disclosure, the optical system may include an optical telescope configured to relay the emitted optical signal toward the optical output element.

In an aspect of the present disclosure, the optical output element may include a flat surface to which the transmitted optical signal is incident and upon which a portion of the transmitted optical signal is reflected, and an optical window or an interference filter.

In an aspect of the present disclosure, the direction selective optical component may include an optical circulator configured to separate forward and backward propagating optical signals.

In an aspect of the present disclosure, the system may include an optical power detector configured to measure optical power back-coupled into the direction selective optical component.

In an aspect of the present disclosure, the direction selective optical component may include a fiber optic coupler configured to route a portion of back-coupled optical power to the optical power detector.

In an aspect of the present disclosure, the optical power detector may be configured to generate an electrical signal corresponding to an amount of back-coupled optical power.

In an aspect of the present disclosure, the laser source and the optical power detector may be configured to determine a ratio of back-coupled optical power to transmitted optical power to evaluate changes in beam divergence, optical alignment, or an angular response of the fast-steering mirror.

In accordance with aspects of the present disclosure, a method for remotely detecting and measuring optical system misalignments includes propagating an optical signal through a direction selective optical component; emitting the optical signal into free-space via a fiber end; collimating the optical signal emitted from the fiber end with a fiber collimator; controlling a pointing direction of the optical signal in free-space once emitted by the fiber end with a fast-steering mirror; relaying the emitted optical signal with an optical system; and transmitting the optical signal through an optical output element, wherein a portion of the optical signal is reflected from the optical output element, back-coupled through the fiber collimator, and routed through the direction selective optical component to detect a pointing misalignment.

In an aspect of the present disclosure, the method may further include transmitting the optical signal including at least one wavelength from a laser source.

In an aspect of the present disclosure, the method may further include relaying the emitted optical signal toward the optical output element through an optical telescope.

In an aspect of the present disclosure, the method may further include reflecting a portion of the transmitted optical signal from a flat surface of the optical output element.

In an aspect of the present disclosure, the method may further include providing the optical output element as at least one of an optical window or an interference filter.

In an aspect of the present disclosure, the method may further include routing the back-coupled optical signal within the direction selective optical component by an optical circulator to separate forward and backward propagating optical signals.

In an aspect of the present disclosure, the method may further include directing a portion of the back-coupled optical signal to an optical power detector through a fiber optic coupler.

In an aspect of the present disclosure, the method may further include measuring optical power back-coupled into the direction selective optical component with an optical power detector.

In an aspect of the present disclosure, the method may further include generating an electrical signal corresponding to an amount of back-coupled optical power.

In an aspect of the present disclosure, the method may further include determining a ratio of back-coupled optical power to transmitted optical power to evaluate changes in beam divergence, optical alignment, or an angular response of the fast-steering mirror.

In accordance with aspects of the present disclosure, a system for compact self-referenced alignment calibration in a free-space optical transmitter includes a laser source configured to generate and transmit an optical signal; a direction selective optical component coupled to the laser source and configured to propagate the optical signal, the direction selective optical component including an optical circulator configured to separate forward and backward propagating optical signals and a fiber optic coupler configured to route a portion of a back-coupled optical signal to an optical power detector; a fiber end coupled to the direction selective optical component and configured to emit the optical signal into free-space; a fiber collimator positioned to collimate the optical signal emitted from the fiber end; a fast-steering mirror positioned to receive the collimated optical signal, the fast-steering mirror including an opto-mechanical device configured to scan and deflect the optical signal within two mutually orthogonal planes; an optical system including an optical telescope configured to relay and direct the scanned optical signal toward an optical output element including an optical window or an interference filter having a flat reflective surface upon which the transmitted optical signal is incident and from which a portion of the optical signal is reflected; and the optical power detector coupled to the direction selective optical component and configured to measure optical power back-coupled from the optical output element through the optical system, the fast-steering mirror, and the fiber collimator, wherein the optical power detector is further configured to generate an electrical signal corresponding to a measured amount of back-coupled optical power; wherein the laser source and the optical power detector are configured to determine a ratio of back-coupled optical power to transmitted optical power to evaluate changes in beam divergence, optical alignment, or an angular response of the fast-steering mirror; and wherein the system is configured to determine a position of maximum back-coupled optical power corresponding to a transmit-beam direction that produces a maximum back-coupled response from the flat reflective surface of the optical output element and to detect deviations therefrom as optical misalignments.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a diagram of a system for remotely detecting and measuring optical system misalignments, in accordance with aspects of the present disclosure;

FIG. 2 is a graph of normalized back-coupled optical power versus a fast-steering mirror deflection angle in one plane, in accordance with aspects of the present disclosure;

FIG. 3 is a graph of an exemplary response of the system of FIG. 1, in accordance with aspects of the present disclosure;

FIG. 4 is a block diagram of a controller configured for use with the system of FIG. 1, in accordance with aspects of the present disclosure; and

FIG. 5 is a flowchart of a method for remotely detecting and measuring optical system misalignments, in accordance with aspects of the present disclosure.

### DETAILED DESCRIPTION

The present disclosure relates generally to systems and methods for detecting, characterizing, and compensating optical system misalignments in free-space optical communication transmitters, and in particular to systems and methods for performing controlled generation, scanning, and measurement of optical beam alignment states using inherent beam steering capabilities and optical power feedback through a transmission fiber. The present disclosure allows for precise determination of transmitter pointing direction relative to an output optical element, facilitates in situ calibration of optical alignment without external sensors, and provides a compact, self-referenced means of maintaining optimal beam alignment under varying environmental and mechanical conditions for reliable FSO communication performance.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

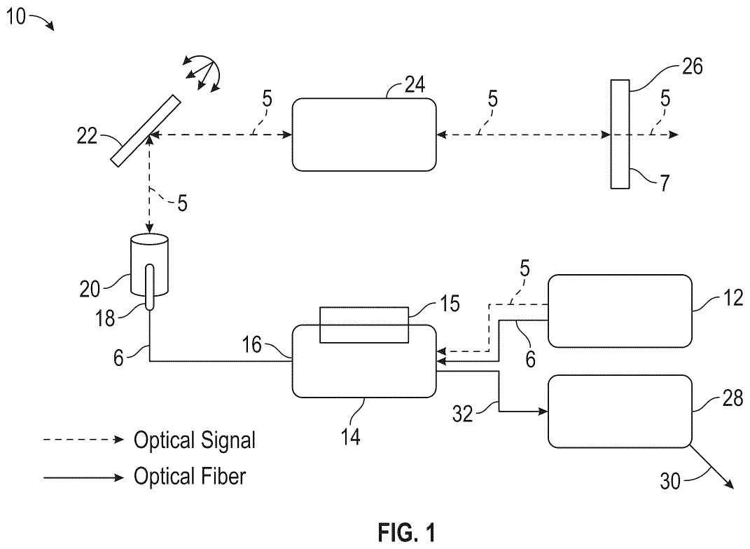

Referring to FIG. 1, a system 10 for remotely detecting and measuring optical system misalignments is shown. System 10 includes a laser source 12, a direction selective optical component 14, a distal end 16, a fiber end 18, a fiber collimator 20, a fast-steering mirror 22, an optical system 24, an optical output element 26 with a flat surface 7, and an optical power detector 28. The system 10 is structured to produce a self-referenced alignment response by steering an emitted beam toward an internal reference plane, capturing a small and controlled reflection from that plane, and measuring back-coupled power that returns through the same optical launch path. This configuration allows direct and repeatable or continuous measurement of angular pointing errors and internal optical misalignments without the need for external targets, additional imaging sensors, or auxiliary optical hardware. The system 10 operates by using the existing transmission path of a free-space optical terminal, which ensures that any detected misalignment reflects true deviations within the optical train rather than alignment errors from independent monitoring systems. Because it references the same optics used for beam emission, the system 10 maintains alignment integrity even when external conditions such as temperature changes, structural flexure, or mechanical vibration affect optical stability. This architecture supports autonomous, in-situ verification of optical alignment in real time, making it suitable for both ground-based and spaceborne free-space communication terminals, precision laser pointing systems, and optical metrology instruments where post-deployment adjustment is difficult or impossible.

The laser source 12 provides an optical signal 5, including at least one wavelength, used for scan response generation and back-coupled power measurement. In embodiments, the laser source 12 is a diode laser, a distributed feedback laser, a vertical cavity surface emitting laser, a fiber laser, diode-seeded fiber laser, or a diode pumped solid state source depending on the required wavelength and output characteristics. The selection of wavelength is based on the operating environment of system 10, spectral properties of a selected optical output element 26, detector responsivity, and eye safety requirements. Suitable wavelengths include, but are not limited to, 850 nanometers, 980 nanometers, and 1064 nanometers for near infrared applications, 1310 nanometers and 1550 nanometers for free-space optical communication systems that require low atmospheric attenuation and Class 1 eye-safe operation, also wavelengths allocated in range of infrared telecommunication bands like S-band (1460-1530 nanometers), C-band (1530-1565 nanometers) or L-band (1565-1625 nanometers), and mid infrared wavelengths between two and five micrometers for systems operating in high temperature or dusty environments where scattering must be minimized. In other embodiments, visible wavelengths such as 532 nanometers or 635 nanometers are used for alignment and diagnostic purposes when visual confirmation of beam position is desirable.

The laser source 12 may provide output power levels ranging from tens of microwatts for laboratory calibration to tens of milliwatts for typical operational links, and in some embodiments may provide higher output powers in the watt-level range, including up to about 10 watts, for long-range, high-loss, or space-based terminals. The optical output may be single mode or multi-mode depending on beam quality requirements. The laser source 12 may include an integrated thermoelectric cooler, precision thermistor, and feedback control electronics to maintain temperature stability and wavelength constancy within a few picometers across a wide range of environmental conditions. For spaceborne or aeronautical applications, the laser source 12 may be hermetically sealed and radiation hardened. The package may include redundant emitters or optical isolators to protect against back reflections that could destabilize the lasing cavity.

The optical signal 5 generated by the laser source 12 is transmitted through an optical fiber 6 that connects to the direction selective optical component 14. The optical fiber 6 preserves the optical signal 5 mode profile and polarization with minimal insertion loss. In embodiments, the optical fiber 6 is a single mode fiber with a core diameter between five and ten micrometers and a numerical aperture between 0.1 and 0.15, allowing efficient coupling to the fiber collimator 20 and minimizing divergence. The optical fiber 6 may include a polarization maintaining structure when the polarization state of the optical signal 5 is used for diagnostic or control functions. The optical fiber 6 can be fabricated from silica, fluoride glass, or chalcogenide glass depending on the selected wavelength range. For operation at mid infrared wavelengths, the optical fiber 6 may be a hollow core photonic crystal fiber or an indium fluoride fiber that provides low absorption losses.

In embodiments, the optical fiber 6 is terminated with FC/APC, FC/PC, or SMA connectors that minimize Fresnel reflections and maintain low return loss. The angled physical contact (APC) interface is preferred to prevent spurious reflections that could interfere with the back-coupled measurement. In permanent installations, fusion splicing is used to join the optical fiber 6 to the laser source 12, producing a near reflection free junction. The fiber coating may include polyimide or acrylate materials for temperature stability and mechanical protection, and the fiber may be jacketed with stainless steel or polyether ether ketone (PEEK) for vacuum or aerospace environments. The length of the optical fiber 6 may range from several centimeters in compact bench systems to several meters in full scale free-space optical terminals, depending on spatial configuration and mechanical routing requirements.

In embodiments, the laser source 12 provides intensity modulation or a superimposed pilot tone to facilitate lock in detection of the back-coupled optical power. The modulation frequency may range from a few kilohertz to several megahertz depending on detector bandwidth and desired signal to noise ratio. This improves discrimination of weak back-reflections from the optical output element 26 and allows dynamic tracking during fast-steering mirror 22 scans. The laser source 12 may also include an internal optical isolator or a Faraday rotator that suppresses feedback into the gain cavity, ensuring measurement accuracy when reflected light reenters the system through the optical fiber 6.

The direction selective optical component 14 provides controlled routing of optical power within the system 10, directing the forward-propagating optical signal 5 toward the fiber end 18 while simultaneously defining a return path for the back-coupled reflection that is measured by the optical power detector 28. The purpose of the direction selective optical component 14 is to isolate the laser source 12 from potentially destabilizing optical feedback while maintaining high transmission efficiency in both the forward and backward directions. The direction selective optical component 14 is configured to maintain low insertion loss, high isolation, and minimal polarization dependence to preserve the integrity of the optical signal 5 across the full range of environmental and operational conditions.

In embodiments, the direction selective optical component 14 includes an optical circulator 15 (e.g., a fiber optical circulator) configured to separate forward and backward propagating light between three optical ports. The optical circulator 15 directs the optical signal 5 from the laser source 12 through the optical fiber 6 to the fiber end 18 while routing the returning reflected light from the optical output element 26 toward the optical power detector 28. The optical circulator 15 may be based on the Faraday rotation effect, employing magneto-optic materials such as yttrium iron garnet in combination with birefringent crystal elements or polarization beam displacers. This provides non-reciprocal transmission that prevents the back-coupled optical signal from re-entering the laser source 12. The optical circulator 15 may achieve isolation greater than 35 decibels, insertion loss less than 1 decibel, and return loss exceeding 50 decibels across a wavelength range of 800 to 1600 nanometers. In embodiments, high-power or broadband operation may require optical circulators 15 with even higher isolation, up to 50 decibels, or specialized coatings that maintain polarization purity in harsh environments. The optical circulator 15 housing may be fabricated from stainless steel, aluminum, or titanium to provide mechanical stability and thermal management. For spaceborne applications, the optical circulator 15 may be hermetically sealed, with optical fibers pigtail bonded through glass-to-metal feedthroughs to ensure performance under vacuum and radiation exposure.

In embodiments, the direction selective optical component 14 includes a fiber optic coupler 32 that functions as a passive beam splitter for dividing or combining optical power between the forward and backward propagation paths. The fiber optic coupler 32 may have a fixed split ratio selected according to measurement requirements. Exemplary ratios include 99:1, 98:2, or 95:5, which allow a small portion of the forward optical signal 5 to be monitored for power reference while preserving most of the optical power for transmission toward the optical system 24. The same fiber optic coupler 32 allows a controlled fraction of the back-coupled signal to be directed toward the optical power detector 28. The fiber optic coupler 32 may be fabricated as a fused biconical taper device, where two optical fibers 6 are heated and stretched together to create an evanescent coupling region. In other embodiments, the fiber optic coupler 32 is implemented as a planar lightwave circuit splitter constructed on a silica or silicon substrate, which provides greater thermal and mechanical stability. Integrated photonic versions may employ silicon nitride or lithium niobate waveguides that maintain polarization with extremely low polarization-dependent loss, typically below 0.1 decibel. The fiber optic coupler 32 may be optimized for single-mode operation with minimal excess loss and wavelength-dependent splitting variation less than 0.5 percent across a 100-nanometer bandwidth.

In some embodiments, the direction selective optical component 14 includes both the optical circulator 15 and the fiber optic coupler 32 connected in series to achieve both high isolation and flexible signal monitoring. The optical circulator 15 directs the main optical signal 5 through the system 10, while the fiber optic coupler 32 provides a controlled sampling of the forward or backward power.

In further embodiments, the direction selective optical component 14 may incorporate additional optical elements such as optical isolators, wavelength-selective filters, or polarizers to enhance system performance. For example, an integrated isolator may be positioned upstream of the optical circulator 15 to provide additional protection for the laser source 12. A narrowband interference filter may be used to reject unwanted background illumination or to limit the detected wavelength range when the system 10 operates under bright ambient conditions. Polarization controllers or polarization-maintaining fiber pigtails may be added to preserve the state of polarization between the laser source 12 and the optical power detector 28. The optical fibers attached to the direction selective optical component 14 may be jacketed with steel or aramid-reinforced coatings for strain relief, and the overall device length may range from 20 millimeters to 60 millimeters depending on construction and port spacing.

The distal end 16 defines the reference position of the optical fiber 6 relative to the rest of the assembly and therefore plays a critical role in the mechanical and thermal stability of the system 10. Misalignment or drift at this location can result in significant degradation of back-coupled power measurement accuracy, as even sub-degree angular deviations or micron-level positional shifts can alter the overlap between the returning reflected beam and the fiber core.

In embodiments, the distal end 16 may be a precision ferrule, sleeve, or monolithic mounting seat designed to hold the optical fiber 6 in a fixed and repeatable position. The ferrule may be cylindrical or keyed to prevent rotation and may incorporate alignment grooves or flats that establish precise optical axis orientation. Suitable materials for the distal end 16 include zirconia ceramic, Kovar®, stainless steel, titanium, or glass-filled polymer. Dimensional tolerances at the distal end 16 are typically maintained within sub-micron to low-micron ranges to ensure stable optical performance. Axial concentricity between the fiber bore and the mechanical reference surface may be controlled to better than 10 micrometers, and angular tilt may be maintained below 0.2 degrees to prevent beam walk-off through the fiber collimator 20 optics. The inner diameter of the distal end 16 may range from 125 micrometers to 250 micrometers for single-mode and multimode fibers respectively, with a surface finish below 0.05 micrometers to reduce micro-stress and potential birefringence in the optical fiber 6. The overall length of the distal end 16 may range from 2 millimeters to 10 millimeters depending on the assembly design and whether mechanical keying or flexure features are integrated.

In embodiments, the distal end 16 includes a compliant or flexure-based submount that isolates the fiber end 18 from stresses originating in the surrounding areas. The compliant structure may include spring-loaded titanium arms, miniature bellows, or polymeric damping elements that accommodate thermal expansion and mechanical vibration. The flexure geometry may be designed to allow limited motion in axial and radial directions while maintaining precise angular alignment.

Bonding or fastening at the distal end 16 may be achieved using low outgassing, radiation-tolerant adhesives such as epoxy resins or silicone-based compounds qualified for aerospace use. In vacuum or high-temperature environments, metal-to-ceramic brazing or glass frit bonding may be employed to create a hermetic seal that maintains mechanical integrity while avoiding organic materials. In laboratory or low-temperature environments, ultraviolet-cured adhesives or low-modulus optical-grade silicones may be used to facilitate replacement or rework of the fiber end 18. Surface coatings or anodization may be applied to the distal end 16 to reduce corrosion and improve adhesion of encapsulants.

In some embodiments, the fiber end 18 may include integrated alignment features that simplify assembly and calibration. For example, precision dowel holes or reference flats can be machined directly into the fiber end 18 to interface with the baseplate or the fiber collimator 20 housing. A keyed design may define a single, reproducible angular orientation of the polarization axis when polarization-maintaining fiber is used. In compact implementations, the fiber end 18 may form part of a hybrid optical connector that combines mechanical retention, thermal conduction, and electrical grounding for the laser source 12.

The fiber end 18 serves as the emitting termination from which the optical signal 5 exits into free-space. The fiber end 18 is positioned at the distal end 16 of the direction selective optical component 14 and establishes the fundamental optical interface between the guided mode within the optical fiber 6 and the free-space propagation path formed by the fiber collimator 20.

In embodiments, the fiber end 18 is formed from a single optical fiber 6, such as a single-mode or polarization-maintaining fiber, that terminates in an angle-cleaved surface designed to suppress unwanted Fresnel reflections. A typical cleave angle is approximately eight degrees relative to the normal of the fiber axis, although the angle may vary from six to twelve degrees depending on the numerical aperture and refractive index of the fiber material. The angle deflects any residual reflected light away from the fiber core, preventing destabilizing optical feedback into the laser source 12 and maintaining consistent measurement conditions. For applications requiring precise beam quality and minimal reflection sensitivity, the fiber end 18 may be polished to optical-grade quality with a surface finish of 40-20 scratch-dig or better. The end-face flatness may be controlled within one micrometer across the core region, and the apex offset of the cleaved angle may be maintained within ±3 micrometers to ensure stable output pointing.

In other embodiments, the fiber end 18 includes additional optical modifications to control beam shape or polarization. The fiber end 18 may be end-capped with a short section of index-matched glass or fused silica to increase the damage threshold and reduce the risk of contamination at the fiber surface. The end-cap may have an anti-reflection coating optimized for the operating wavelength, with a residual reflectivity below 0.2 percent. In further embodiments, the fiber end 18 is integrated with a micro-lens such as a ball lens, aspheric lens, or graded-index lens that pre-collimates the emerging optical signal 5 before it reaches the fiber collimator 20.

The fiber end 18 may also be configured for polarization-sensitive operation. In such embodiments, the fiber end 18 terminates a polarization-maintaining optical fiber 6 in which the slow axis is mechanically registered to a key or alignment feature at the distal end 16. This ensures that the polarization state of the optical signal 5 remains stable with respect to the optical system 24 and minimizes response drift caused by polarization rotation or temperature-induced birefringence. The fiber cladding and jacket may be marked or keyed to preserve consistent orientation during assembly and maintenance.

In embodiments, the fiber end 18 is not limited to a single optical fiber 6 but may instead be composed of two or more optical fibers 6 arranged in a defined spatial configuration. Multiple optical fibers 6 may be used to generate parallel beams, perform differential alignment measurements, or measure angular misalignments along orthogonal directions simultaneously. For example, two optical fibers 6 placed side-by-side at the fiber end 18 may emit two slightly separated beams that are both reflected by the optical output element 26. Arrays of optical fibers 6 arranged in linear, triangular, or hexagonal patterns may also be used to create structured illumination patterns or to provide redundancy in case of partial optical degradation. In such configurations, the fiber end 18 may be fabricated as a monolithic multi-fiber ferrule, where each optical fiber 6 is precisely positioned within a ceramic or metallic substrate with sub-micron alignment tolerances.

In additional embodiments, the fiber end 18 may include a bundled or fused optical fiber 6 array in which multiple cores share a common cladding. Such designs reduce footprint while allowing collective alignment measurements over multiple spatial points. The collective back-coupled power from all optical fibers 6 can be analyzed to detect asymmetric misalignments or beam distortions within the optical system 24. The fiber end 18 may therefore serve both as an emitter and as an optical probe array for comprehensive system 10 calibration.

The choice of materials and coatings for the fiber end 18 depends on the operational environment. Silica-based fibers with dopants such as germanium or fluorine provide high optical transmission for wavelengths up to approximately 2 micrometers, while fluoride or chalcogenide glass fibers may be selected for mid-infrared operation up to 5 micrometers. The protective coatings may include polyimide for high-temperature tolerance, acrylate for general-purpose use, or metal coatings such as aluminum or gold for vacuum or radiation environments. Each fiber end 18, whether single or multi-fiber, may be hermetically sealed with low-outgassing adhesives or glass-to-metal joints when used in spaceborne or high-vacuum systems.

The fiber collimator 20 expands and collimates the optical signal 5 emitted from the fiber end 18 into a well-defined free-space beam that propagates toward the fast-steering mirror 22 and the optical system 24. The fiber collimator 20 determines the divergence, beam diameter, and wavefront quality of the optical signal 5 and therefore plays a central role in the precision and sensitivity of the back-coupled power measurement. Its design ensures that the emitted beam maintains consistent geometry under varying thermal, mechanical, and optical loading conditions.

In embodiments, the fiber collimator 20 may employ various optical architectures depending on the wavelength range, available space, and environmental requirements. The fiber collimator 20 may be an aspheric lens collimator that uses a single aspheric element to minimize spherical aberration and achieve diffraction-limited performance. In other embodiments, the fiber collimator 20 may be an achromatic doublet collimator composed of two cemented elements made from glasses of differing dispersion, such as BK7 and SF5, to minimize chromatic aberrations over broadband operation or in systems using multiple laser wavelengths. For near-to mid-infrared operation, the fiber collimator 20 may include infrared-transmitting materials such as calcium fluoride, zinc selenide, or chalcogenide glass.

In certain embodiments, the fiber collimator 20 may be a graded-index (GRIN) lens collimator, which uses a radial refractive index profile to collimate the emerging optical signal 5 without requiring complex alignment. For high-precision laboratory systems or long-range free-space transmitters, the fiber collimator 20 may be reflective, using an off-axis parabolic mirror that eliminates chromatic aberrations and maintains diffraction-limited performance across wide wavelength ranges.

The focal length and numerical aperture of the fiber collimator 20 are chosen to produce a beam diameter matched to the entrance pupil of the optical system 24. For compact transmitters, this diameter may range from 1 millimeter to 10 millimeters, while for large-aperture optical terminals, beam diameters up to 50 millimeters may be used. The focal length of the fiber collimator 20 typically ranges from 2 millimeters for short-focus GRIN lenses to 100 millimeters for long-focus parabolic systems. The divergence of the collimated beam is inversely related to the output aperture diameter and may be maintained between 0.05 and 5 milliradians, depending on system 10 configuration. Beam circularity and wavefront error are critical for accurate back-coupling and thus, the optical surfaces of the fiber collimator 20 are manufactured to a flatness of λ/10 peak-to-valley or better and a surface roughness below 10 nanometers RMS.

Optical coatings applied to the fiber collimator 20 surfaces are designed to maximize transmission and minimize reflection losses at the operating wavelength. For near-infrared operation, broadband anti-reflection coatings may provide transmission above 99 percent across the 900 to 1600 nanometer range. In mid-infrared systems, specialized coatings such as thorium-free fluoride or multilayer dielectric stacks may be used to achieve comparable performance while ensuring environmental durability. These coatings also help to maintain a symmetric back-coupled signal by preventing ghost reflections that could interfere with the main beam.

The fiber collimator 20 may be housed in a precision-machined barrel that includes threaded focus adjustment with a locking nut to allow fine-tuning of the collimation distance. In other embodiments, the fiber collimator 20 includes athermal spacers made from materials with compensating coefficients of thermal expansion, such as Invar® or Zerodur®, which preserve the focal position across temperature variations from −40 degrees Celsius to +85 degrees Celsius. The fiber collimator 20 may also be bonded monolithically to the distal end 16 using low-outgassing, thermally stable adhesives or optical contacting techniques to suppress micro-motion that could lead to beam-pointing jitter or alignment drift.

In high-vibration or spaceborne environments, the fiber collimator 20 may be implemented as a ruggedized assembly with epoxy-free mechanical retention, shock isolation features, and alignment pins that constrain the optical axis. For vacuum applications, metallic or ceramic fiber collimator 20 housings may be preferred over polymeric components to prevent outgassing and to enhance dimensional stability. In precision laboratory or metrology applications, the fiber collimator 20 may incorporate piezoelectric actuators that provide active focus adjustment to compensate for small variations in fiber position or thermal expansion.

The fiber collimator 20 may also be integrated with polarization-maintaining or multi-fiber configurations. In polarization-maintaining systems, the fiber collimator 20 optics may include birefringence compensation elements such as quartz rotators or polarization beam-splitting coatings to maintain the desired polarization state of the optical signal 5. In multi-fiber embodiments, a single large-aperture fiber collimator 20 lens or mirror may be used to collimate multiple beams emitted from multiple fiber ends 18, producing an array of parallel beams for differential alignment measurements.

The fast-steering mirror 22 provides precise angular control of the collimated beam and is used to scan the optical signal 5 across two mutually orthogonal axes to determine the angular condition that produces maximum back-coupled power. This angular scanning process allows the system 10 to identify and quantify optical misalignments by detecting changes in reflected intensity as the beam is swept over the optical output element 26. The fast-steering mirror 22 forms the core dynamic component of the alignment measurement mechanism, as it establishes a direct relationship between mirror deflection angle and received signal strength. High positional precision, angular repeatability, and mechanical stability are required to ensure accurate reconstruction of alignment profiles and reproducible calibration results.

In embodiments, the fast-steering mirror 22 may be implemented using several actuator technologies depending on performance requirements, scan range, and operating environment. For applications that require large angular excursions with moderate bandwidth, the fast-steering mirror 22 may be a voice coil tip tilt stage. For fine alignment and high precision operation, the fast-steering mirror 22 may be a piezoelectric tip tilt stage. These stages generally achieve angular ranges of ±0.5 degrees or less per axis and are used when small misalignment corrections or high frequency scanning is required.

In other embodiments, the fast-steering mirror 22 may be a galvanometer mirror pair, where two orthogonally mounted galvanometers independently control horizontal and vertical beam deflection. For miniaturized systems, such as those intended for compact terminals or space constrained platforms, the fast-steering mirror 22 may be a microelectromechanical system (MEMS) mirror. MEMS based fast-steering mirror 22 may achieve angular ranges of ±0.2 degrees to ±2 degrees per axis with sub microradian precision and can be fabricated using silicon micromachining techniques with gold or aluminum reflective coatings.

The reflective surface of the fast-steering mirror 22 determines both the beam quality and the measurement sensitivity. The fast-steering mirror 22 substrate may be fabricated from low expansion materials such as fused silica, Zerodur®, beryllium, or silicon carbide to maintain surface figure under thermal and mechanical stress. The reflective surface flatness is maintained at λ/10 or better at the operating wavelength to preserve wavefront quality and avoid introducing phase errors that could affect back coupling efficiency. For broadband operation, protected silver or enhanced aluminum coatings may be applied to the reflective surface, providing reflectivity greater than 98 percent across the visible and near infrared spectrum. In systems requiring high durability or operation in corrosive or high humidity environments, dielectric multilayer coatings may be used to achieve similar reflectivity while providing superior resistance to oxidation and mechanical wear.

The actuation mechanism of the fast-steering mirror 22 may operate in open loop or closed loop configurations. In open loop mode, the relationship between applied voltage and fast-steering mirror 22 angle is determined during calibration and stored in a lookup table or polynomial model. This configuration is suitable for systems with predictable and stable actuator behavior. In closed loop mode, integrated position sensors such as capacitive, optical, or strain gauge sensors continuously monitor the mirror orientation and provide feedback to the control electronics to maintain precise angular positioning. Closed loop control allows the system 10 to achieve repeatability sufficient to return to a previously measured peak alignment position with sub microradian precision even after environmental disturbances or power cycles.

The scanning motion produced by the fast-steering mirror 22 can follow different patterns depending on the measurement objective. For rapid alignment verification, a one-dimensional sweep may be used to identify the angular position of maximum back-coupled power along a single axis. For comprehensive calibration, the fast-steering mirror 22 may execute a two-dimensional raster or spiral scan across a defined angular field, typically spanning ±0.5 degrees to ±5 degrees per axis. The data from each scan can be fitted to a Gaussian or other suitable function to determine the precise angular offset between the transmitted beam and the normal of the flat surface 7 of the optical output element 26.

In embodiments, the mechanical housing of the fast-steering mirror 22 may include vibration isolators, flexure hinges, or magnetic bearings to reduce mechanical noise and cross-coupling between axes. For spaceborne or airborne applications, the assembly may be designed for high shock survivability and low thermal distortion. The entire fast-steering mirror 22 assembly may be enclosed in a sealed or purged housing to prevent particulate contamination or condensation on the reflective surface. Electrical connections may be routed through shielded cables to minimize electromagnetic interference with the optical power detector 28 or other sensitive electronics.

The optical system 24 relays the steered optical signal 5 from the fast-steering mirror 22 to the optical output element 26 and defines the beam diameter, wavefront quality, and angular convergence at the flat surface 7. This assembly establishes the final optical path of the transmitted beam and therefore directly influences the alignment sensitivity, efficiency, and repeatability of the back-coupled power measurement. The optical system 24 serves as both a relay and conditioning subsystem, ensuring that the collimated beam from the fiber collimator 20 is properly expanded or focused to match the aperture of the optical output element 26 and that the wavefront arriving at the flat surface 7 is free of distortion or tilt. In operation, the optical system 24 determines the geometric relationship between the outgoing beam and the reference plane of the flat surface 7, setting the nominal condition under which the back-coupled signal reaches its maximum intensity.

In embodiments, the optical system 24 may be configured as a Galilean telescope or a Keplerian telescope depending on packaging constraints and optical requirements. In other embodiments, the optical system 24 may be a Keplerian telescope configuration, which employs two positive lens elements separated by the sum of their focal lengths. The Keplerian configuration is particularly advantageous for laboratory systems or high-precision optical terminals where control of beam quality and spatial mode purity is critical.

Refractive embodiments of the optical system 24 may utilize optical materials such as fused silica, BK7, SF11, or low-dispersion glass depending on the operational wavelength and spectral bandwidth. In broadband systems that operate over multiple wavelengths or when the optical system 24 is shared between alignment and communication channels, achromatic or apochromatic doublets may be used to maintain focus and beam shape across wide spectral ranges. For mid-infrared operation, materials such as calcium fluoride, zinc selenide, or barium fluoride may be selected for their low absorption and dispersion properties.

In reflective embodiments, the optical system 24 may be composed of one or more mirrors configured as an off-axis reflective telescope, such as a Cassegrain, Gregorian, or afocal relay. Reflective optics provide inherently achromatic performance and can be scaled to large apertures without introducing chromatic aberration. Mirror substrates may be made from low-expansion materials such as Zerodur®, silicon carbide, beryllium, or fused silica to ensure dimensional stability across temperature cycles. Reflective coatings such as protected aluminum, silver, or multilayer dielectric coatings may be applied to achieve reflectivity above 98 percent across the operational wavelength range. These coatings may also include overcoats of silicon dioxide or magnesium fluoride to improve durability and resistance to environmental degradation.

The optical system 24 may be designed to produce an output beam diameter ranging from 10 millimeters to 150 millimeters, depending on the optical link budget, transmitter class, and intended range. Smaller apertures, typically between 10 and 30 millimeters, are used for compact short-range transmitters or laboratory setups, while larger apertures, up to 150 millimeters or more, are used in long-range or space communication systems where beam divergence must be minimized to achieve high coupling efficiency with distant receivers. The focal length and separation of optical elements within the optical system 24 are selected to produce a beam that is nearly collimated at the optical output element 26, ensuring that the reflected portion from the flat surface 7 retraces its path accurately back through the system.

To maintain high-quality wavefronts and stable back coupling characteristics, optical surfaces within the optical system 24 may be manufactured to flatness better than λ/10 peak-to-valley and surface roughness below 10 nanometers root mean square. The system alignment may be referenced to the optical axis of the fast-steering mirror 22 to ensure that angular deflections introduced during scanning are transmitted linearly to the output aperture. Internal baffles or light traps may be incorporated to suppress stray reflections and ghost images that could interfere with the reflected signal.

The mechanical structure of the optical system 24 may be constructed from aluminum, titanium, Invar®, or carbon-fiber-reinforced polymer depending on weight, stiffness, and thermal performance requirements. In space-qualified or vacuum-rated systems, a monolithic optical bench may be used to mount the lenses or mirrors, maintaining positional tolerances of better than 10 micrometers across the full operating temperature range. Adjustable mounts with fine-pitch screws or flexure mechanisms may allow tip, tilt, and focus alignment during assembly. Once alignment is completed, the optical elements of the optical system 24 may be bonded or clamped in place using athermal spacers to ensure long-term stability under launch loads, vibration, and thermal cycling.

Mechanical alignment of the optical system 24 defines the transmit axis of the optical signal 5 and thereby sets the reference geometry for determining optical misalignment. The transmit axis is mechanically referenced to the surface normal of the flat surface 7 of the optical output element 26, which represents the zero-point condition for angular calibration. During calibration, the fast-steering mirror 22 scans the beam until the back-coupled power is maximized, thereby identifying the optical condition under which the transmitted beam is normal to the flat surface 7. This alignment establishes the baseline from which subsequent angular deviations are measured.

In additional embodiments, the optical system 24 may include adaptive elements or compensators such as deformable mirrors or motorized focusing lenses to correct for thermally induced or mechanical misalignments during operation. These adaptive components can automatically maintain beam quality and alignment in response to environmental changes. Optical encoders, interferometric sensors, or laser tracking modules may also be integrated into the optical system 24 for real-time monitoring of optical axis stability.

The optical output element 26 defines the external optical aperture of the system 10 and includes the flat surface 7 that functions as the internal angular reference plane for alignment measurement. The optical output element 26 represents the final optical interface between the internal optical system 24 and the external free-space environment, and its surface quality and reflectance properties directly affect the accuracy, stability, and repeatability of the back-coupled power response. The optical output element 26 provides a controlled reflective reference that allows the system 10 to determine when the transmitted beam is aligned normal to the output aperture and thereby serves as the calibration surface for detecting optical misalignments.

In embodiments, the optical output element 26 may be implemented as a precision optical window made from high-quality optical materials such as fused silica, aluminosilicate glass, or sapphire. Each of these materials can be fabricated to optical-grade flatness and parallelism, ensuring that the reflected and transmitted beams remain spatially and angularly stable during scanning operations.

In some embodiments, the optical output element 26 and/or the flat surface 7 is oriented at a predetermined non-normal angle relative to an optical axis of the optical system 24. The predetermined angle is selected such that, during normal pointing operation, specular reflections from the flat surface 7 are not coupled back into the optical system 24 for deflection angles of the fast-steering mirror 22 within a nominal operating range. In this manner, back-coupled power attributable to the flat surface 7 is substantially suppressed or eliminated over the deflection angles of the fast-steering mirror 22 corresponding to normal pointing operation, while remaining available for alignment and calibration measurements outside the nominal operating range.

In other embodiments, the optical output element 26 may function as an interference filter that transmits the primary communication or measurement wavelength while reflecting a small, well-calibrated portion of the same or a nearby wavelength for alignment verification. In broadband or dual-wavelength systems, the optical output element 26 may be designed to transmit the communication band (e.g., 1,550 nanometers) while reflecting a separate alignment wavelength (e.g., 1,540 nanometers) to isolate the alignment signal from the main transmission channel.

The surface flatness of the flat surface 7 is maintained to λ/10 or better over the illuminated area to ensure consistent specular reflection and minimize phase distortions in the reflected wavefront. Surface parallelism between the inner and outer faces of the optical output element 26 may be held within five arcseconds to prevent beam walk-off through the optical system 24. The surface finish typically meets or exceeds 40-20 scratch-dig standards to prevent scattering that could degrade the back-coupled measurement signal.

The placement of the flat surface 7 within the optical output element 26 may vary depending on the operational requirements of the system 10. In some embodiments, the flat surface 7 is located on the interior side of the optical output element 26 to protect it from environmental contamination such as dust, condensation, or impact. In other embodiments, particularly for terrestrial applications where access is available, the flat surface 7 may be located on the exterior side of the optical output element 26, allowing in situ cleaning or wipe-down maintenance when necessary.

Optical coatings applied to the flat surface 7 are engineered to achieve a specific, stable reflectance and high transmission at the operational wavelength. Coatings may include broadband anti-reflection layers or partially reflective dielectric stacks designed to maintain reflection levels within a controlled range of 0.1 percent to 2 percent. This reflectance level ensures that the back-coupled optical power detected by the optical power detector 28 remains within its linear dynamic range across the expected variations in transmission loss or atmospheric attenuation. In systems that operate at multiple wavelengths or over wide temperature ranges, the coating may incorporate multi-band or athermal designs that maintain consistent spectral performance under varying environmental conditions.

In addition to reflective coatings, protective layers may be applied to extend the operational lifetime and calibration stability of the optical output element 26. Hydrophobic or oleophobic coatings can prevent water, oil, and dust accumulation, while anti-soiling or anti-static coatings reduce contamination from airborne particles. Hard overcoats, such as silicon dioxide or diamond-like carbon, can be applied to improve scratch resistance and protect the optical surface during handling or operation in abrasive environments. For high-humidity or corrosive environments, protective edge-sealing compounds or hermetic mounts may be added to prevent moisture ingress and preserve coating adhesion.

The optical output element 26 may have thicknesses ranging from 1 millimeter to 20 millimeters depending on aperture size and mechanical stress requirements. The clear aperture may vary from 10 millimeters for compact systems to 150 millimeters for large free-space optical terminals. The optical output element 26 may be mounted into the optical system 24 using a kinematic or athermal mount designed to minimize stress and maintain optical flatness across temperature variations.

In embodiments, the optical output element 26 may include integrated sensors or optical fiducials to support automated calibration and alignment verification. Alternatively, small laser-etched reference marks or fiducials may be applied to the flat surface 7 to facilitate optical metrology during assembly and field calibration.

In embodiments, the optical power detector 28 may be a semiconductor photodiode, a thermal detector, or another photosensitive device selected according to the wavelength of operation, required sensitivity, and environmental constraints. For systems operating in the visible or near-infrared range (e.g., 850 nanometers or 980 nanometers), the optical power detector 28 may be a silicon (Si) photodiode, which provides high quantum efficiency, low noise, and fast temporal response. For longer wavelengths, such as 1310 nanometers or 1550 nanometers, the optical power detector 28 may be an indium gallium arsenide (InGaAs) photodiode, which offers extended infrared responsivity and stable performance across a broad temperature range. For mid-infrared or broadband systems operating beyond 2 micrometers, the optical power detector 28 may be a thermopile, pyroelectric, or mercury cadmium telluride (MCT) detector, which measures total absorbed power rather than individual photons and provides wavelength-independent response suitable for high-power or uncooled operation.

The active area of the optical power detector 28 is selected based on the expected mode field and alignment tolerance of the returning optical beam. Typical optical power detector 28 diameters range from 0.3 millimeters for tightly focused fiber-coupled systems to 3 millimeters or greater for multimode or free-space return paths. A smaller active area provides higher bandwidth and lower capacitance, while a larger active area increases alignment tolerance and collection efficiency. In high-precision systems, the optical power detector 28 may include a focusing lens or fiber pigtail to improve coupling efficiency and reduce sensitivity to beam position fluctuations.

In embodiments, the optical power detector 28 is integrated with a low-noise transimpedance amplifier that converts the photocurrent into a voltage signal with appropriate gain and bandwidth. The amplifier bandwidth is chosen to match the fastest scanning rates of the fast-steering mirror 22, ensuring that rapid variations in back-coupled power are accurately captured without signal distortion. For typical scan rates between 10 hertz and several kilohertz, the amplifier bandwidth may range from tens of kilohertz to several megahertz. The noise equivalent power (NEP) of the optical power detector 28 may be below 10-12 watts per root hertz for high-sensitivity Si or InGaAs detectors, allowing the detection of weak reflected signals down to sub-nanowatt levels.

In additional embodiments, the optical power detector 28 is integrated in-line with the optical fiber 6 such that a controlled fraction of the in-fiber propagating optical signal 5 and/or a back-coupled optical signal 5 is tapped and directed to an integrated photodetector element. In such implementations, the optical power detector 28 may include an integrated tap coupler, waveguide splitter, or equivalent optical sampling structure formed within the same package or substrate as the photodetector, thereby providing in-fiber monitoring with reduced part count and improved mechanical robustness. The tapped power may be converted to electrical signal 30 for use as a forward power reference, a back-coupled power measurement, or both, depending on the routing configuration. In some embodiments, the optical power detector 28 provides both optical sampling and directional routing functionality when implemented with an integrated non-reciprocal or wavelength-selective structure, and therefore may perform at least a portion of the functions otherwise provided by the direction selective optical component 14 and the optical power detector 28 as separate elements.

The linearity and temperature stability of the optical power detector 28 are essential for ensuring accurate and repeatable alignment measurements. The optical power detector 28 is selected or calibrated to maintain linear response over the expected range of optical power, typically from −50 decibels-milliwatt to +10 decibels-milliwatt. The temperature coefficient of responsivity may be kept below 0.1 percent per degree Celsius to prevent drift in measured intensity under changing thermal conditions. For improved thermal stability, the optical power detector 28 may be mounted on a metal core printed circuit board or directly attached to a thermally conductive substrate such as copper or aluminum nitride.

The optical power detector 28 housing may be hermetically sealed to prevent moisture ingress and protect sensitive junctions from contamination. The housing material may include aluminum, nickel-plated brass, stainless steel, or ceramic depending on environmental requirements. A heat sink or thermoelectric cooler may be included to maintain the junction temperature within a few degrees Celsius of a setpoint, ensuring consistent responsivity and low noise over extended scan sequences or high-duty operation.

In additional embodiments, the optical power detector 28 may be part of a dual-detector configuration, where one detector monitors the transmitted optical power through the fiber optic coupler 32 while the other measures the back-coupled signal. The ratio between these signals provides a normalized measure of system alignment independent of fluctuations in laser source 12 output. In systems requiring time-resolved measurements, the optical power detector 28 may be replaced with an avalanche photodiode (APD) or photomultiplier tube (PMT) to increase sensitivity and dynamic range. APD detectors may be operated in linear or Geiger mode depending on required gain and response time, with typical gains of 10 to 100 for linear operation and greater than 105 for photon-counting systems.

The optical power detector 28 may also include integrated electronics for automatic gain control, offset correction, and temperature compensation. These circuits maintain constant output levels even when back-coupled power varies by orders of magnitude due to mechanical perturbations or beam clipping in the optical system 24. An electrical signal 30 may be digitized by an analog-to-digital converter and analyzed in real time by a microcontroller, field-programmable gate array (FPGA), or dedicated signal-processing unit to determine the alignment state and update calibration parameters.

For ruggedized or spaceborne implementations, the optical power detector 28 and its associated electronics may be mounted on vibration-isolated platforms or encapsulated in radiation-hard materials. Shielded wiring and electromagnetic interference (EMI) filters may be incorporated to prevent coupling of electrical noise into the detection circuitry. In compact systems, the optical power detector 28 may be integrated directly into the direction selective optical component 14, forming a monolithic detection assembly that reduces optical path length and improves immunity to alignment drift.

Electrical signal 30 is produced by the optical power detector 28 and serves as a quantitative representation of the back-coupled optical power as a function of the angular position or scan state of the fast-steering mirror 22. The electrical signal 30 provides the fundamental data used to determine the precise optical alignment condition of the system 10, including the position of maximum back-coupled power, the width of the alignment response, and the ratio between reflected and transmitted power.

In embodiments, the electrical signal 30 is processed through high-resolution digitization and digital signal analysis to extract accurate alignment parameters. The analog output from the optical power detector 28 is converted to digital form using an analog-to-digital converter (ADC) with a minimum of 16-bit resolution to preserve fine variations in detected signal strength. Higher-resolution converters, such as 18-bit or 24-bit delta-sigma ADCs, may be used in systems requiring sub-microradian angular precision or long-term stability under fluctuating signal levels. The sampling rate may range from several kilohertz for slow alignment scans to several megahertz for high-speed scanning operations where the fast-steering mirror 22 executes continuous or oscillatory movements. This allows the system 10 to record the back-coupled power profile across the entire angular scan in real time.

Digital processing of the electrical signal 30 may include averaging to reduce random noise, finite impulse response (FIR) or infinite impulse response (IIR) filtering to suppress high-frequency fluctuations, and baseline subtraction to correct for optical power detector 28 dark current or stray background light. In high-precision embodiments, advanced signal conditioning may be applied, including adaptive smoothing, polynomial fitting, and fast Fourier transform (FFT) filtering to isolate the true back-coupled response from environmental noise or vibration-induced artifacts. Peak-finding algorithms, such as parabolic or Gaussian curve fitting, may then be used to locate the precise angular position of the maximum signal with sub-sample accuracy. This peak position corresponds to the condition where the transmitted optical signal 5 is normal to the flat surface 7 of the optical output element 26 and therefore defines the calibrated zero-point alignment of the system.

In configurations where the fiber optic coupler 32 is integrated into the direction selective optical component 14, the electrical signal 30 may include a second measurement channel that monitors a fraction of the forward transmitted power. This dual-channel arrangement allows computation of a ratio between back-coupled optical power and transmitted optical power, providing a normalized measure that compensates for variations in laser source 12 intensity, detector responsivity, or environmental attenuation.

The processed electrical signal 30, along with derived metrics such as the fitted peak position, response width, power ratio, and overall signal amplitude, may be stored in nonvolatile memory for system calibration, long-term monitoring, and diagnostic purposes. In embodiments, these data may be logged periodically or continuously during operation and periodically analyzed for trend identification or predictive maintenance. A slow drift in the peak position over time may indicate gradual mechanical deformation or thermal expansion within the optical system 24, while an increase in response width may signify degradation of beam quality, beam divergence, or an angular response of the fast-steering mirror 22.

In addition to post-processing, real-time feedback control may be implemented using electrical signal 30 to automatically adjust the fast-steering mirror 22 and maintain optimal alignment. In such embodiments, the electrical signal 30 is continuously analyzed by a digital controller or field-programmable gate array (FPGA) that updates mirror position commands to maximize back-coupled power. This feedback loop provides closed-loop alignment stabilization capable of compensating for slow drifts or dynamic disturbances during operation.

The electrical signal 30 may also be used as part of a diagnostic framework for system-level verification and post-event analysis. In spaceborne or remote applications, the recorded electrical signal 30 data may be transmitted to ground stations or control centers for detailed examination. Parameters such as signal amplitude stability, peak angular position, peak shape symmetry, and response width are indicators of optical integrity and can be used to assess whether the optical system 24 or fast-steering mirror 22 has undergone mechanical or thermal stress.

In embodiments requiring traceability or safety-critical operation, each measurement of the electrical signal 30 may be time-stamped and stored alongside environmental data such as temperature, vibration level, and orientation, creating a complete record of alignment conditions. Such data logging allows correlation between environmental events and optical misalignment trends, allowing for predictive maintenance and minimizing downtime.

During use, the system 10 performs an automated or controlled scan sequence in which the fast-steering mirror 22 deflects the collimated beam through a range of angular positions while the optical power detector 28 continuously records the corresponding electrical signal 30. This scanning process establishes a quantitative mapping between beam pointing direction and back-coupled optical power, providing a direct indication of the system's angular alignment relative to the reference plane defined by the flat surface 7 of the optical output element 26. The scan can be executed along one or two orthogonal axes, depending on whether a single-axis or full two-dimensional alignment characterization is required.

In a one-dimensional scan, the fast-steering mirror 22 sweeps the optical signal 5 across a single angular axis, either horizontal or vertical, while the optical power detector 28 measures the corresponding back-coupled power at each step. The resulting electrical signal 30 forms a Gaussian-like curve with a clear maximum, which represents the precise angular position at which the transmitted beam is normal to the flat surface 7. The width of the response curve provides information about the optical divergence of the beam and/or fast-steering mirror 22 angular response, while the amplitude and symmetry of the peak indicate overall optical quality and alignment precision. Once the peak position is identified, the system 10 can adjust the fast-steering mirror 22 or related components to restore optimal beam pointing in real time or record the offset for later calibration.

In a two-dimensional scan, the fast-steering mirror 22 performs an angular sweep across both axes, typically following a raster or spiral pattern that covers a defined angular field of view. The optical power detector 28 simultaneously records the back-coupled intensity across all scan points, generating a two-dimensional response map. This map exhibits a bright central lobe corresponding to the direction where the beam is perpendicular to the flat surface 7 and where the optical system 24 achieves maximum back-coupling efficiency. The shape, symmetry, and diameter of this lobe are directly related to the optical beam divergence, the scan step size, fast-steering mirror 22 angular response, and the focusing characteristics of the fiber collimator 20 and optical system 24. A perfectly aligned and well-collimated system yields a circular, symmetric lobe centered at the nominal alignment axis, while distortions or asymmetries in the lobe indicate optical aberrations, alignment errors, fast-steering mirror 22 angular response irregularities, or surface irregularities on the optical output element 26.

Repeated measurements over time, temperature, or mechanical stress provide valuable diagnostic insight into the stability of the optical alignment. By comparing successive scans, the system 10 can detect gradual changes in peak position that indicate mechanical shifts, thermal expansion, fast-steering mirror 22 response changes, or optical mount creep within the optical system 24 or fiber collimator 20 assembly. Simultaneous monitoring of the ratio between back-coupled and transmitted power, determined through the fiber optic coupler 32 reference, and response curve width allows differentiation between changes in beam divergence and variations in the scaling or gain of the fast-steering mirror 22. For instance, if the measured peak amplitude remains stable but response width changes, this indicates some changes in fast-steering mirror 22 scaling (e.g., angular response versus control unit value). Conversely, if both amplitude and response width change proportionally, this can indicate beam divergence change or beam quality degradation.

During operation, the entire scan sequence and corresponding electrical signal 30 data may be analyzed in real time by a digital controller, microprocessor, or FPGA-based processor to identify the maximum response point and compute beam alignment corrections. The results may also be stored for long-term analysis, allowing the system 10 to track trends in alignment drift, actuator performance, and optical beam divergence. Such data can be used for predictive maintenance, ensuring the system remains within required alignment tolerances without human intervention.

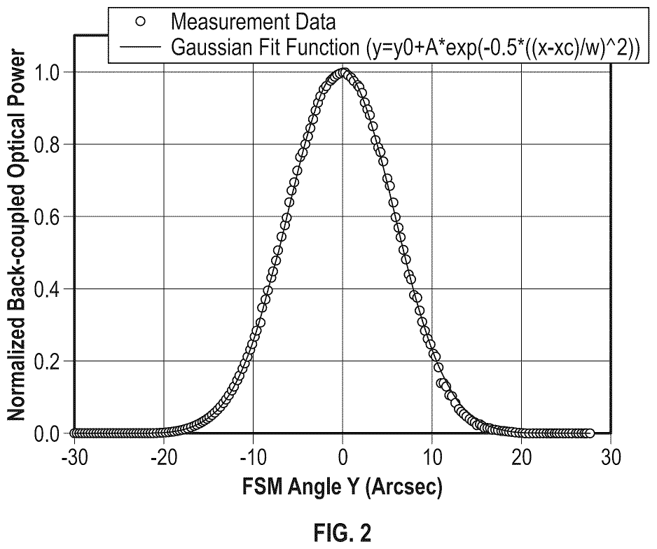

FIG. 2 demonstrates the characteristic dependence between the normalized back-coupled optical power and the angular deflection of the fast-steering mirror 22 in one plane. FIG. 2 illustrates how the optical power returning through the fiber collimator 20 and direction selective optical component 14 varies as the transmitted beam is incrementally deflected from the condition where it is normal to the flat surface 7 of the optical output element 26. As the fast-steering mirror 22 adjusts the beam's angular direction, the position of the reflected beam spot shifts transversely across the surface of the fiber end 18. This movement changes the overlap between the returning optical mode and the guided mode of the optical fiber 6, producing a smooth variation in back-coupled optical power that follows a Gaussian dependence on angular displacement.

In the plot shown in FIG. 2, the horizontal axis represents the deflection angle of the fast-steering mirror 22, expressed in mechanical or electrical control units, while the vertical axis represents the normalized optical power measured by the optical power detector 28. Experimental data points are shown as discrete markers, and the continuous line represents the Gaussian fit function. The peak of this curve corresponds to the angular position where the transmitted beam is perfectly aligned, when the optical axis of the system 10 is perpendicular to the flat surface 7 of the optical output element 26. The full-width-at-half-maximum (FWHM) of the Gaussian curve indicates the effective angular sensitivity of the system 10 and is determined by the beam divergence of the beam incident to optical output element 26 and the optical geometry of the fast-steering mirror 22 and optical system 24.

In embodiments, the typical width of the Gaussian response depends on output beam divergence and can range from tens of microradians to milliradians depending on system 10 design. The measured response also reflects the precision of the fast-steering mirror 22; linearity or hysteresis in its control signal may slightly distort the curve from the theoretical Gaussian shape.

The normalized curve presented in FIG. 2 is fundamental to the calibration and alignment process of the system 10. It demonstrates that the maximum back-coupled optical power occurs at the exact alignment condition, providing an unambiguous reference for detecting optical misalignments. By scanning across a defined angular range, the system can determine both the direction and magnitude of pointing errors. Deviations in the peak position correspond to angular offsets between the transmitter beam and the reference plane of the optical output element 26, while variations in peak height or curve width indicate changes in beam divergence, optical throughput, or the response characteristics of the fast-steering mirror 22.

In operation, this Gaussian response allows the system 10 to quantify angular alignment with high precision using only power measurements, eliminating the need for external imaging sensors. Because the curve is normalized to the transmitted power measured through the fiber optic coupler 32, environmental fluctuations or laser source 12 power variations do not affect the accuracy of alignment determination.

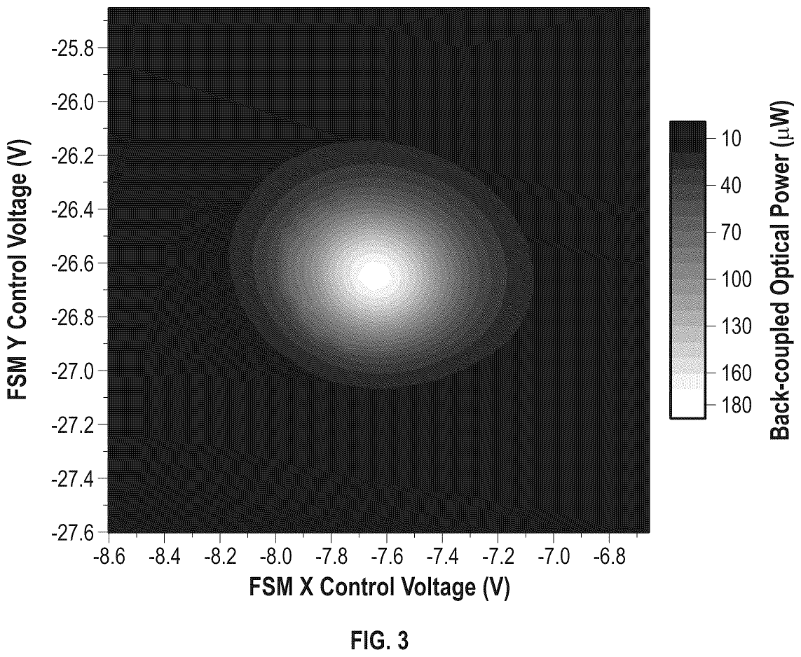

FIG. 3 demonstrates an exemplary response profile of the system 10 during a two-dimensional angular scan of the fast-steering mirror 22. The figure illustrates how the back-coupled optical power, as measured by the optical power detector 28, varies across both orthogonal scan axes, typically referred to as the azimuth (X) and elevation (Y) deflection directions. The plotted data reveal a bright lobe centered at the angular coordinates corresponding to perfect optical alignment, where the transmitted optical signal 5 is normal to the flat surface 7 of the optical output element 26. The intensity of this lobe represents the normalized back-coupled optical power, and its position, shape, and width provide comprehensive information about the alignment, beam divergence, fast-steering mirror 22 angular response, and optical quality of the system 10.

As shown in FIG. 3, the central peak of the two-dimensional response map corresponds to the condition of maximum optical overlap between the reflected return beam and the guided mode of the optical fiber 6. This maximum defines the angular orientation at which output optical signal 5 is perpendicular to the flat surface 7. Moving away from the central peak along either axis causes the overlap to decrease, resulting in a rapid drop in back-coupled optical power. The resulting surface profile resembles a two-dimensional Gaussian distribution, with the width of the lobe determined by the divergence of the collimated optical signal 5 produced by the system 10 and by the optical alignment sensitivity (including fast-steering mirror 22 response) inherent to the optical system 24.

In embodiments, the angular extent of the central lobe is typically on the order of a hundred microradians. Narrower lobes indicate tighter beam collimation, higher mode purity, and better optical alignment, while broader lobes may result from larger beam divergence, multimode propagation, or partial misfocus in the system 10. The full-width-at-half-maximum (FWHM) of the lobe in both axes defines the angular sensitivity of the system 10 and can be used to calibrate the fast-steering mirror 22 response to absolute angular units. The symmetry of the lobe serves as a diagnostic indicator: a circular and uniform lobe indicates that the optical system 24 and the flat surface 7 are well aligned with respect to the optical axis, whereas an elliptical or tilted lobe may indicate mechanical misalignment and optical distortion, thermal expansion, or misalignment in the mounting of the fast-steering mirror 22.

The contour lines or color gradients shown in FIG. 3 may represent equal levels of normalized back-coupled optical power. In embodiments, these contours are used to visualize how the alignment sensitivity changes across the scanned angular field. The sharpness and concentricity of the contours reveal the degree of optical symmetry in the system 10. Deviations or irregularities in contour shape can signal aberrations in the optical system 24, surface curvature in the flat surface 7, or beam asymmetries originating from the fiber end 18 or fiber collimator 20. This visualization therefore functions as both a quantitative alignment reference and a diagnostic map of optical quality and mechanical stability.

In practical operation, the system 10 uses the data represented in FIG. 3 to locate the center of the lobe through numerical fitting or centroid analysis. The fast-steering mirror 22 can then be positioned at that center angle to achieve optimal alignment automatically. When environmental changes occur, such as thermal shifts or mechanical stress, repeating the scan produces a new response map that can be compared to the stored reference. Any offset of the lobe center corresponds to a measurable change in pointing direction, and any change in the lobe's width or symmetry corresponds to variations in optical divergence or angular response. These measurements provide continuous quantitative feedback for self-correcting operation.

In embodiments, the response shown in FIG. 3 may also be normalized by the transmitted power measured through the fiber optic coupler 32, providing a ratio-based calibration that compensates for laser power fluctuations or detector gain drift. This normalization ensures that alignment measurements remain accurate even under varying optical throughput conditions. When applied in long-term operation, repeated two-dimensional scans produce a series of response maps that can be archived to monitor alignment stability over the operational lifetime of the system 10.

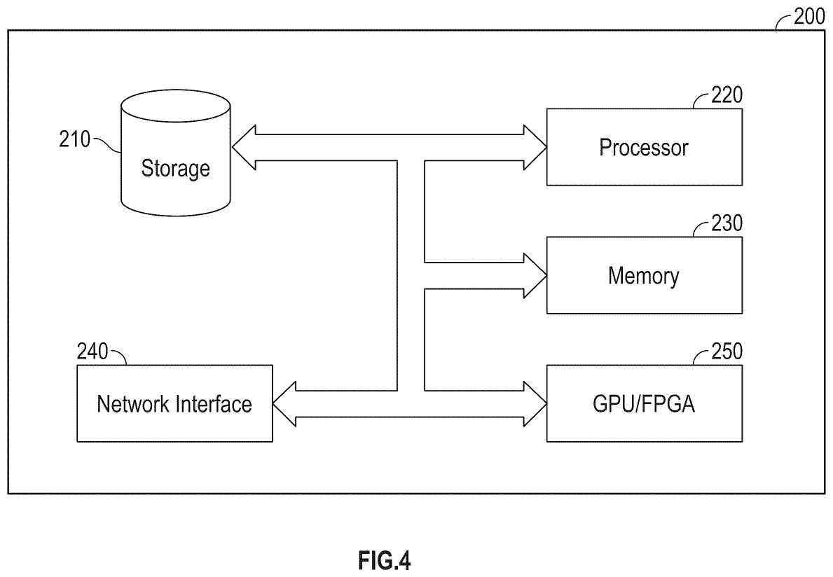

Referring to FIG. 4, a controller 200 is shown. The controller 200 is arranged to coordinate, regulate, and stabilize operation of the system 10 during scanning, detection, and analysis of back-coupled optical power for alignment calibration. The controller 200 communicates with and manages the laser source 12, the fast-steering mirror 22, and the optical power detector 28 to ensure precise synchronization between beam deflection, signal acquisition, and data processing. The controller 200 includes a storage unit 210, a processor 220, a memory 230, a network interface 240, and a GPU/FPGA 250. These elements operate together to deliver deterministic control of mirror deflection patterns, sampling rate timing, and analysis of the electrical signal 30 produced by the optical power detector 28. The controller 200 may operate locally as part of the transmitter housing or remotely through a networked supervisory computer, providing automated control, real-time visualization, and predictive alignment maintenance across multiple terminals.

The storage unit 210 provides nonvolatile data retention for the controller 200 and serves as a repository for both operational and calibration data. The storage unit 210 may contain firmware images, mirror calibration lookup tables, optical scan patterns, laser source modulation parameters, and long-term logs of system health metrics. These stored datasets may include time-stamped records of peak locations, beam divergence values, optical power ratios, and temperature data collected during alignment scans. In embodiments, the storage unit 210 includes solid-state drives or radiation-tolerant flash memory designed for operation in vacuum or aerospace conditions. The storage unit 210 supports transactional updates and checksum verification to ensure data integrity during system power cycling or communication interruptions. Data organization within the storage unit 210 allows structured storage of scan histories and alignment trend data for predictive maintenance and mission assurance.

The processor 220 provides centralized computational control for the controller 200. The processor 220 may be a microprocessor, microcontroller, digital signal processor, or central processing unit configured to execute embedded control firmware or a real-time operating system. In operation, the processor 220 orchestrates calibration sequences, initializes hardware elements, manages closed-loop control of the fast-steering mirror 22, and executes algorithms to locate the peak of the back-coupled optical response curve. The processor 220 can perform numerical fitting routines such as Gaussian or polynomial regression to extract parameters such as beam divergence, peak power, and angular offset from acquired data. It can also generate control waveforms that drive the fast-steering mirror 22 to perform linear, raster, or spiral scans over defined angular ranges. The processor 220 may further execute adaptive optimization routines that reduce scan step size near expected alignment peaks for faster convergence.

The memory 230 is operatively connected to the processor 220 and provides volatile and nonvolatile storage for runtime data, control parameters, and software routines. The memory 230 may include random-access memory for buffering real-time data streams from the optical power detector 28, lookup tables for mirror calibration, and algorithms for dynamic gain correction of the detector amplifier. In embodiments, the memory 230 maintains rolling buffers of raw and processed electrical signal 30 data during scans, ensuring that transient events and intermediate results are preserved. Calibration matrices stored in the memory 230 may link optical power readings to mechanical positions of the fast-steering mirror 22, allowing accurate reconstruction of angular response maps. The memory 230 also holds temperature compensation coefficients for the laser source 12, scaling factors for detector sensitivity, and stored reference profiles used to detect long-term alignment drift.

The network interface 240 provides wired or wireless connectivity between the controller 200 and external computers or supervisory control systems. Through the network interface 240, operators can monitor alignment in real time, initiate scan sequences, or retrieve historical alignment data. The network interface 240 may include Ethernet, serial, optical, or radio-frequency links depending on deployment environment. In spaceborne or remote terrestrial systems, the network interface 240 may communicate over telemetry or command channels to provide remote health reporting and autonomous calibration scheduling. Secure communication protocols may be implemented for command authentication and data integrity. In embodiments, the network interface 240 also allows synchronization between multiple optical terminals, coordinating simultaneous alignment calibration across distributed free-space optical communication nodes.

The GPU/FPGA 250 is coupled to the processor 220 and provides high-speed, hardware-accelerated processing for real-time acquisition and analysis of optical power data. The GPU/FPGA 250 may execute digital signal-processing pipelines that include analog-to-digital conversion, signal averaging, filtering, and peak detection at high throughput rates. In embodiments, the GPU/FPGA 250 performs fitting of the back-coupled power curve to a Gaussian function and computes alignment error vectors that can be fed directly to the fast-steering mirror 22 control loop. The GPU/FPGA 250 may generate precise waveform sequences to drive the mirror actuators, coordinating angular deflection timing with optical power sampling intervals to maintain deterministic phase relationships between actuation and measurement. It can also handle multi-channel data when both the back-coupled and transmitted optical powers are simultaneously monitored through the fiber optic coupler 32, ensuring accurate ratio computation without latency.

In embodiments, the controller 200 may further include a mirror drive module (not shown) electrically coupled to the fast-steering mirror 22. The mirror drive module may provide analog or digital control signals that determine angular deflection amplitude and frequency. It may operate in direct current, sinusoidal, triangular, or arbitrary waveform modes to perform one-dimensional or two-dimensional scans. Closed-loop feedback from integrated mirror position sensors may be used to correct for hysteresis or actuator nonlinearity, ensuring angular accuracy within microradian-level tolerances. For high-dynamic-range operation, the mirror drive module may implement dual-stage amplification and low-pass filtering to suppress noise.

In other embodiments, the controller 200 may include a laser control interface (not shown) coupled to the laser source 12 for modulation and power management. This interface can regulate the output intensity of the laser source 12, apply amplitude modulation for lock-in detection, or synchronize power modulation with mirror scanning to enhance signal-to-noise ratio. The interface may incorporate a thermoelectric control loop that stabilizes the laser source 12 wavelength, and a bias current driver with feedback control to maintain consistent optical output across temperature variations.

A timing module (not shown) may also be integrated within the controller 200 and operatively coupled to both the processor 220 and GPU/FPGA 250. The timing module may generate precision clock signals to coordinate the fast-steering mirror 22 deflection cycles, optical power detector 28 sampling, and data acquisition. It may include phase-locked loops and programmable delay elements that ensure sub-microsecond synchronization between actuation and detection, thereby maintaining high spatial resolution in the reconstructed angular response maps.

During operation, the processor 220 executes the stored control algorithms in the memory 230 to coordinate the system elements. A representative operational sequence may include initializing the fast-steering mirror 22 and laser source 12, verifying signal integrity from the optical power detector 28, and commanding the mirror to perform a predefined angular scan pattern. The GPU/FPGA 250 collects and filters the resulting electrical signal 30 in real time, identifies the peak corresponding to maximum back-coupled power, and transmits this result to the processor 220. The processor 220 computes any angular deviation relative to a stored reference and commands corrective actuation to restore alignment. Once stabilized, the network interface 240 can transmit the measured alignment data to remote systems for monitoring or archiving.

In some embodiments, feedback subsystems (not shown) within the controller 200 may continuously analyze the electrical signal 30 to detect alignment drift. These subsystems may compute error values between the measured and reference peak positions, apply proportional-integral-derivative control laws, and adjust mirror bias voltages to re-center the beam automatically. This feedback capability allows the system 10 to maintain alignment even under thermal expansion, mechanical vibration, or platform motion.

Through these coordinated functions, the controller 200 maintains precise synchronization, alignment stability, and operational reliability within the system 10. The integration of high-speed computation in the processor 220, real-time signal processing and waveform synthesis in the GPU/FPGA 250, deterministic timing control, robust data storage in the storage unit 210, responsive working memory in the memory 230, and reliable connectivity through the network interface 240 allows the system 10 to perform continuous, self-referenced optical alignment calibration under varying environmental conditions. This architecture supports autonomous alignment verification for free-space optical transmitters deployed in terrestrial, airborne, or spaceborne platforms, ensuring long-term accuracy and reducing maintenance requirements across mission lifetimes.

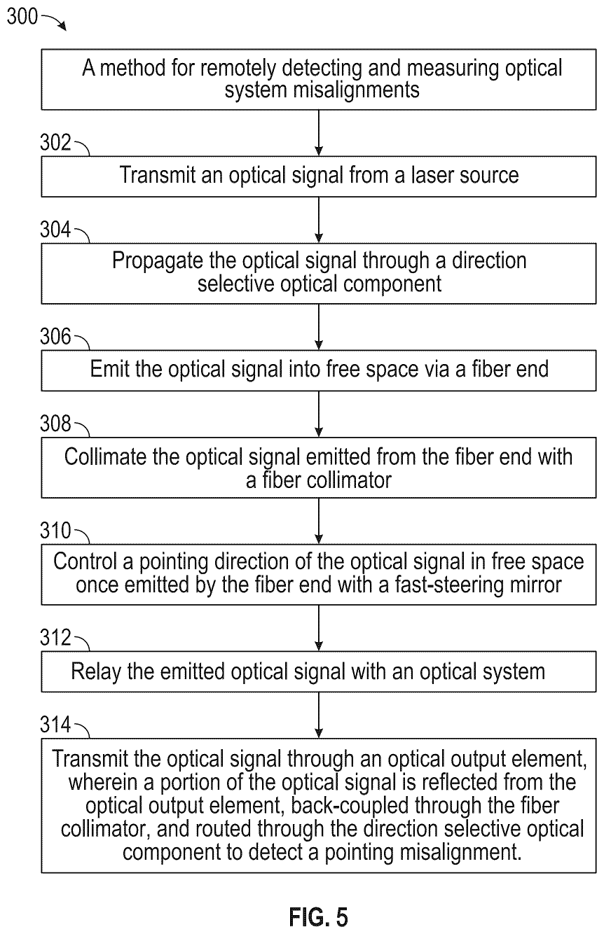

Referring to FIG. 5, a method 300 for remotely detecting and measuring optical system misalignments is shown. The method 300 employs the optical path and system components described previously as part of the system 10, including the laser source 12, the direction selective optical component 14, the fiber end 18, the fiber collimator 20, the fast-steering mirror 22, the optical system 24, the optical output element 26, and the optical power detector 28.

Block 302 includes transmitting optical signal 5 from the laser source 12. The optical signal 5 is generated as a coherent or partially coherent beam that propagates through the optical system and serves as the measurement signal for alignment calibration. In embodiments, the laser source 12 may be a continuous-wave diode laser, a distributed feedback laser, a vertical-cavity surface-emitting laser, a diode-pumped solid-state, a fiber laser, or a diode-seeded fiber laser. Wavelengths may range from 850 nanometers to 1550 nanometers for eye-safe operation or extend into the mid-infrared for high-transmission atmospheric applications. The laser source 12 may be operated in continuous or modulated mode and may include thermoelectric temperature stabilization to maintain wavelength and power stability during extended scans.

Block 304 includes propagating the optical signal 5 through the direction selective optical component 14. The direction selective optical component 14 provides an optical routing function that isolates the laser source 12 from back-reflected light while transmitting the forward-propagating beam toward the fiber end 18. In embodiments, the direction selective optical component 14 may include an optical circulator that separates forward and backward optical signals using Faraday rotation or birefringent elements, providing greater than 35 decibels of isolation. In other embodiments, the direction selective optical component 14 may include a fiber optic coupler that divides optical power according to a defined split ratio, such as 99:1 or 98:2, to create a stable power reference or to route a portion of the return light to the optical power detector 28. In other embodiments, the optical power detector 28 is integrated in-line with the optical fiber 6, wherein a portion of the optical signal 5 propagating in the optical fiber 6 is coupled to the optical power detector 28. In such embodiments, the optical power detector 28 may perform both (i) an optical sampling and routing function otherwise provided by the direction selective optical component 14 and (ii) the optical power detection function of the optical power detector 28, thereby implementing the functions of the direction selective optical component 14 and the optical power detector 28 in a single integrated fiber-coupled component.

Block 306 includes emitting the optical signal 5 into free-space via the fiber end 18. The fiber end 18 serves as the optical transition between the guided fiber mode and the free-space beam. In embodiments, the fiber end 18 may be a single-fiber termination, or multiple fibers arranged in a bundle to emit multiple beams simultaneously for more sophisticated calibration or calibration of multi-aperture systems. Each fiber end 18 may be angle-cleaved, typically at 8 degrees, to suppress Fresnel reflections, and may be anti-reflection coated or end-capped to improve transmission. Surface finish may meet 40-20 scratch-dig or better optical quality, ensuring a smooth, stable beam profile for accurate back-coupling measurements.

Block 308 includes collimating the optical signal 5 emitted from the fiber end 18 using the fiber collimator 20. The fiber collimator 20 converts the diverging beam from the fiber end 18 into a collimated beam suitable for propagation through the free-space optical path. The fiber collimator 20 may be an aspheric lens, an achromatic doublet, or a reflective off-axis parabolic mirror, depending on wavelength and system size. The beam diameter produced by the fiber collimator 20 may range from 1 millimeter to 10 millimeters for compact transmitters and larger systems. The fiber collimator 20 may include anti-reflection coatings with less than 0.2 percent reflectance at the operational wavelength and be constructed with athermalized mounts to maintain focus over a wide temperature range.

Block 310 includes controlling the pointing direction of the collimated optical signal 5 in free-space using the fast-steering mirror 22. The fast-steering mirror 22 adjusts the angular orientation of the transmitted beam to scan across a defined field of view and to identify the alignment position that maximizes back-coupled optical power. The fast-steering mirror 22 may operate as a voice-coil, piezoelectric, galvanometer, or microelectromechanical device. Angular range may vary between ±0.5 degrees and ±5 degrees per axis. The mirror surface may have optical flatness better than λ/10 and high-reflectivity coatings exceeding 97 percent. The fast-steering mirror 22 may operate in open-loop mode using pre-calibrated angular maps or in closed-loop mode with position feedback sensors to ensure repeatability of alignment scans.

Block 312 includes relaying the emitted optical signal 5 with the optical system 24. The optical system 24 functions as the relay assembly that defines the optical path between the fast-steering mirror 22 and the optical output element 26. In embodiments, the optical system 24 may be a Galilean or Keplerian telescope, composed of refractive or reflective elements such as fused silica, BK7 glass, Zerodur®, or silicon carbide mirrors. The optical system 24 establishes the desired beam diameter and wavefront curvature at the optical output element 26. Apertures of the optical system 24 may range from 10 millimeters for laboratory-scale configurations to over 150 millimeters for spaceborne optical terminals. Mechanical mounts may include kinematic seats and flexure interfaces to maintain alignment across vibration and temperature cycles.

Block 314 includes transmitting the optical signal 5 through the optical output element 26. The optical output element 26 defines the external aperture of the system 10 and includes the flat surface 7 that serves as an internal reference plane for alignment measurement. The optical output element 26 may be a window composed of fused silica, BK7 glass, aluminosilicate glass, or sapphire, or an interference filter that transmits a communication wavelength while reflecting a small, calibrated portion of the measurement wavelength. The reflectivity of the flat surface 7 may be tuned between 0.1 percent and 2 percent or higher for specific calibration wavelength to provide an optimal balance between measurement signal strength and system throughput. The reflected portion of the optical signal 5 retraces the optical path through the optical system 24, the fast-steering mirror 22, and the fiber collimator 20, where it is recaptured into optical fiber 6 and routed to the direction selective optical component 14. The resulting back-coupled power level corresponds to the system's alignment state.

In embodiments, the method 300 may further include relaying the emitted optical signal 5 toward the optical output element 26 through an optical telescope configuration within the optical system 24 and reflecting the transmitted optical signal 5 from the flat surface 7 of the optical output element 26 to provide the internal angular reference required for self-referenced calibration.

In some embodiments, the method 300 may further include providing the optical output element 26 as at least one of an optical window or an interference filter configured for partial reflection at the laser source 12 wavelength and routing the back-coupled optical signal within the direction selective optical component 14 using an optical circulator to separate forward and backward propagating optical signals, thereby protecting the laser source 12 from feedback. The optical output element 26 may be formed from glass or from other optically transmissive materials suitable for the operating wavelength and environment. For example, in various embodiments the optical output element 26 may be formed from sapphire, silicon, or another optical material.

Method 300 may further include directing a portion of the back-coupled optical signal to the optical power detector 28 through the fiber optic coupler 32, allowing controlled monitoring of the returned optical power. The method 300 may also further include measuring the back-coupled optical power at the optical power detector 28 and generating an electrical signal 30 corresponding to the measured amount of back-coupled optical power.

In embodiments, the method 300 may further include determining a ratio of back-coupled optical power to transmitted optical power to evaluate changes in beam divergence, angular misalignment, or angular response of fast-steering mirror 22.

Various components are described to illustrate exemplary architectures for generating, steering, relaying, and detecting an optical signal to determine optical misalignment. It is to be understood that such components and arrangements are provided as non-limiting examples. In various embodiments, one or more components may be omitted, combined, rearranged, duplicated, or replaced with other components that are compatible and that provide the same or similar function(s) within the overall system. For example, optical elements may be implemented using refractive, reflective, diffractive, or hybrid optics; beam steering may be implemented using a fast-steering mirror, a MEMS mirror, a galvanometer, an acousto-optic deflector, or another beam deflection mechanism; and directional routing and/or detection may be implemented using one or more circulators, couplers, splitters, isolators, filters, and/or integrated photonic components. Accordingly, the disclosed embodiments encompass variations in which the described components are substituted or reconfigured, provided that the system remains operable to produce a back-coupled optical response that is indicative of an alignment state.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for remotely detecting and measuring optical system misalignments, comprising:
a direction selective optical component configured to propagate an optical signal;
a fiber end disposed along a distal end of the direction selective optical component configured to emit the optical signal into free-space;
a fiber collimator configured to collimate the optical signal emitted from the fiber end;
a fast-steering mirror configured to control a pointing direction of the optical signal in free-space once emitted by the fiber end;
an optical system configured to relay the optical signal; and
an optical output element configured to transmit the optical signal,
wherein a portion of the optical signal is reflected from the optical output element, back-coupled into the fiber collimator, and routed through the direction selective optical component for detection of a pointing misalignment.

2. The system of claim 1, wherein the optical signal comprising at least one wavelength is generated and transmitted by a laser source.

3. The system of claim 1, wherein the fast-steering mirror is an opto-mechanical device configured to deflect a direction of the optical signal within two mutually orthogonal planes.

4. The system of claim 1, wherein the optical system comprises an optical telescope configured to relay the emitted optical signal toward the optical output element.

5. The system of claim 1, wherein the optical output element comprises:
a flat surface to which the transmitted optical signal is incident and upon which a portion of the transmitted optical signal is reflected; and
at least one of an optical window or an interference filter.

6. The system of claim 1, wherein the direction selective optical component comprises an optical circulator configured to separate forward and backward propagating optical signals.

7. The system of claim 2, further comprising an optical power detector configured to measure optical power back-coupled into the direction selective optical component.

8. The system of claim 7, wherein the direction selective optical component comprises a fiber optic coupler configured to route a portion of back-coupled optical power to the optical power detector.

9. The system of claim 8, wherein the optical power detector is configured to generate an electrical signal corresponding to an amount of back-coupled optical power.

10. The system of claim 7, wherein the laser source and the optical power detector are configured to determine a ratio of back-coupled optical power to transmitted optical power to evaluate changes in beam divergence, optical alignment, or an angular response of the fast-steering mirror.

11. A method for remotely detecting and measuring optical system misalignments, comprising:
propagating an optical signal through a direction selective optical component;
emitting the optical signal into free-space via a fiber end;
collimating the optical signal emitted from the fiber end with a fiber collimator;
controlling a pointing direction of the optical signal in free-space once emitted by the fiber end with a fast-steering mirror;
relaying the emitted optical signal with an optical system; and
transmitting the optical signal through an optical output element,
wherein a portion of the optical signal is reflected from the optical output element, back-coupled through the fiber collimator, and routed through the direction selective optical component to detect a pointing misalignment.

12. The method of claim 11, further comprising transmitting the optical signal comprising at least one wavelength from a laser source.

13. The method of claim 11, further comprising relaying the emitted optical signal toward the optical output element through an optical telescope.

14. The method of claim 11, further comprising reflecting a portion of the transmitted optical signal from a flat surface of the optical output element.

15. The method of claim 14, further comprising providing the optical output element as at least one of an optical window or an interference filter.

16. The method of claim 11, further comprising:
routing the back-coupled optical signal within the direction selective optical component by an optical circulator to separate forward and backward propagating optical signals; or
directing a portion of the back-coupled optical signal to an optical power detector through a fiber optic coupler.

17. The method of claim 11, further comprising measuring optical power back-coupled into the direction selective optical component with an optical power detector.

18. The method of claim 17, further comprising generating an electrical signal corresponding to an amount of back-coupled optical power.

19. The method of claim 11, further comprising determining a ratio of back-coupled optical power to transmitted optical power to evaluate changes in beam divergence, optical alignment, or an angular response of the fast-steering mirror.

20. A system for compact self-referenced alignment calibration in a free-space optical transmitter, comprising:
a laser source configured to generate and transmit an optical signal;
a direction selective optical component coupled to the laser source and configured to propagate the optical signal, the direction selective optical component comprising:
an optical circulator configured to separate forward and backward propagating optical signals; and
a fiber optic coupler configured to route a portion of a back-coupled optical signal to an optical power detector;
a fiber end coupled to the direction selective optical component and configured to emit the optical signal into free-space;
a fiber collimator positioned to collimate the optical signal emitted from the fiber end;
a fast-steering mirror positioned to receive the collimated optical signal, the fast-steering mirror comprising an opto-mechanical device configured to scan and deflect the optical signal within two mutually orthogonal planes;
an optical system comprising an optical telescope configured to relay and direct the scanned optical signal toward an optical output element comprising an optical window or an interference filter having a flat reflective surface upon which the transmitted optical signal is incident and from which a portion of the optical signal is reflected; and
the optical power detector coupled to the direction selective optical component and configured to measure optical power back-coupled from the optical output element through the optical system, the fast-steering mirror, and the fiber collimator,
wherein the optical power detector is further configured to generate an electrical signal corresponding to a measured amount of back-coupled optical power;
wherein the laser source and the optical power detector are configured to determine a ratio of back-coupled optical power to transmitted optical power to evaluate changes in beam divergence, optical alignment, or an angular response of the fast-steering mirror, and
wherein the system is configured to determine a position of maximum back-coupled optical power corresponding to a transmit beam direction that produces a maximum back-coupled response from the flat reflective surface of the optical output element and to detect deviations therefrom as optical misalignments.
